(19) United States
(12) Patent Application Publication
(10) Pub. No.: US 2025/0027762 A1
(43) Pub. Date: Jan. 23, 2025

(54) SENSOR DEVICE, MEASURING ARRANGEMENT, AND METHOD FOR ASSEMBLING A SENSOR DEVICE

(71) Applicant: Samson Aktiengesellschaft, Frankfurt am Main (DE)

(72) Inventor: Stefan Kolbenschlag, Darmstadt (DE)

(73) Assignee: Samson Aktiengesellschaft, Frankfurt am Main (DE)

(21) Appl. No.: 18/708,704

(22) PCT Filed: Nov. 11, 2022
(86) PCT No.: PCT/EP2022/081640

§ 371 Date: May 9, 2024

(30) Foreign Application Priority Data
Nov. 12, 2021 (DE) 102021129496.7

(51) Int. Cl. G01B 7/30; G01D 5/16

(52) U.S. Cl. CPC G01B 7/30; G01D 5/16

(57) ABSTRACT

A sensor for a control valve of a process plant (e.g., a chemical plant, a power plant, a food-processing plant) may include a position sensor (e.g., a magnetoresistive position sensor), and a lever arm that may be rotationally movable about a fixed pivot point of the sensor device for converting a linear stroke movement of a control rod of the control valve into a corresponding transmission movement (e.g., rotational transmission movement) which is mapped on the position sensor. The lever arm may have a coupling for position-true, rotationally movable connection of the lever arm to a reference point of the control rod. The lever arm may include at least one first lever section and at least one second lever section movable relative to the first lever section.

### CROSS REFERENCE TO RELATED APPLICATIONS

This patent application is a U.S. National Stage Application of International Application No. PCT/EP2022/081640, filed Nov. 11, 2022, which claims priority to German Patent Application No. 10 2021 129 496.7, filed Nov. 12, 2021, each of which is incorporated herein by reference in its entirety.

### BACKGROUND

### Field

The disclosure relates to a sensor device for a control valve of a process plant, such as a chemical plant, a power plant, a food processing plant, or the like. The disclosure also relates to a measuring arrangement with a sensor device for a control valve with a control rod and a support structure. Furthermore, the disclosure relates to a method for mounting a sensor device on a control valve.

### Related Art

Control valves are generally used in process plants to adjust a process fluid flow. Depending on process variables, disturbance variables and environmental variables, the process fluid flow can have various properties which can be influenced by the control valve in order to bring about an approximation to or identity with desired properties of the process fluid flow upstream or downstream of the control valve. The properties of the process fluid flow relate, for example, to its pressure, volume flow, temperature, composition or similar. For this purpose, the control valve has a through-opening that can be closed by means of a valve member. Many control valves have a through-opening, which is framed by a valve seat, and a movable valve member that is matched to the valve seat in terms of shape, wherein a relative position of the valve member in relation to the valve seat influences one or more properties of the process fluid flow. In many control valves, a fully closed state can be set in which the valve member is in sealing contact with the valve seat. Conventional control valves are arranged to position the valve member in a variety of different open positions relative to the valve seat, so that a variety of different opening widths can be set. The valve member is generally actuated via a linear-moving control rod that is permanently connected to the valve member. The control rod extends out of the fluid-carrying valve housing through a yoke or similar to a control actuator, which can be pneumatic, hydraulic or electric, for example. The control actuator imparts an actuating movement to the control rod, which is transmitted to the actuator by the control rod. The control valve is used to adjust the process fluid flow and thus the process by precisely achieving an optimum closing or opening relative position of the valve member with respect to the valve seat. For precise valve member positioning, control valves usually comprise electronic positioners that receive position signals from a position sensor in order to control the control actuator that moves the control rod and thus the actuator. The precision of the position control is particularly relevant in the portion of the control valve's closed position. The position sensor usually generates the position signal on the basis of a reference position of the control rod. The accuracy of the position control depends on the accuracy with which the position of the actuator rod is detected. The resolution of the sensor system plays a major role here.

DE 38 44 020 A1 describes a displacement sensor for detecting a linear stroke movement of the actuator rod of an actuator of a valve actuator. The displacement sensor uses a Hall sensor arranged between two stationary magnetic poles. The Hall sensor is attached to the pivot point of a lever, the movable end of which is equipped with a sensing pin that is supported by a follower held stationary on the control rod. The follower has a sliding surface aligned perpendicular to the direction of travel of the control rod, on which the sensing pin is held by a spring pre-tension. While the control rod performs a linear stroke movement, the follower pin remains constant on the follower in relation to the stroke direction and pivots around the pivot point so that a travel or position signal relating to the control valve can be generated for a positioner using the Hall sensor. During the pivotable movement, the sensing pin slides transversely to the stroke direction along the sliding surface.

Another angle sensor for a control valve is described in US 2003/0086470 A1. In this angle sensor, a reference pin is permanently connected to the control rod. The lever of the angle sensor has a receiving groove for the reference pin. During a linear stroke movement of the control rod, the reference pin takes the lever with it, wherein a relative movement of the reference pin in relation to the longitudinal direction of the lever is accompanied within the receiving groove. Attached to the lever are magnetic poles that move with the lever around its pivot point. The angle sensor uses a stationary magnetoresistive element to generate a position signal.

DE 42 33 300 C1 and EP 2 061 984 B1 describe various position sensors in which the stroke movement of the control rod of a control valve is sensed by means of a rotary lever which is rotatably mounted together with a rocker lever about a stationary axis, wherein the sensor interacts with the rocker lever. The rocker lever can be used to determine the stroke with increased resolution.

The lever travel is generally mechanically limited to around 60°. The amplitude of the sliding movement of the sensing or reference pin increases disproportionately as the stroke increases. This can result in a very long lever being required for conventional position sensors on control valves with a long stroke, which may require an unacceptably large mounting space. The position measurement accuracy is also impaired as the amplitude of the sliding movement increases.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 a schematic representation of a sensor device according to the disclosure, wherein a lever arm is connected to a reference point located at a second reversal point;

FIG. 2 a schematic representation of the sensor device according to FIG. 1, wherein the reference point is located at a path center point;

FIG. 3 a schematic representation of the sensor device according to FIG. 1, wherein the reference point is located at a first reversal point;

FIG. 4 a perspective view of a sensor device;

FIG. 5 a diagram of the linearity error in relation to stroke position for a sensor device according to the disclosure compared to a conventional sensor device; and

FIG. 6 a diagram of the measurement sensitivity in relation to stroke position for a sensor device according to the disclosure compared to a conventional sensor device.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art.

In other instances, well-known methods, procedures, components, and circuitry have not been described in detail to avoid unnecessarily obscuring embodiments of the disclosure. The connections shown in the figures between functional units or other elements can also be implemented as indirect connections, wherein a connection can be wireless or wired. Functional units can be implemented as hardware, software or a combination of hardware and software.

It can be seen as a task of the disclosures to overcome the disadvantages of the prior art, in particular to provide a position sensor for an actuator device which can provide a high measurement accuracy for a large linear stroke, in particular at least sectionally, preferably in the closed position, and/or a comparatively small installation space requirement.

Accordingly, a sensor device is provided for a control valve of a process plant, such as a chemical plant, a power plant, a food processing plant or the like. The control valve can, for example, be a globe control valve which has an, in particular linear-moving actor, for actuating a linear-moving actuator of the control valve. The linear-moving actuator of the control valve can, for example, be a valve plug or the like, which is translationally movable in a stroke direction relative to a valve seat corresponding to the actuator. In an exemplary embodiment, the actuator and the valve seat are matched to each other in such a way that the valve member can close the valve seat (closed position). Control valves can be designated as “Flow to Close” (FTC) or “Flow to Open” (FTO) in relation between a closing direction of the actuator and a predetermined flow direction of the process fluid on which the control valve acts. Alternatively, the actuator can be positioned at a preferably predetermined and/or selectable distance from the valve seat by means of the stroke rod or control rod by actuation of the control actuator of the control valve. The distance of the actuator relative to the valve seat determines a flow area of the control valve. The control valve is permanently connected to the control rod. A linear control movement of the control valve corresponds to a corresponding, in particular equal, stroke movement of the control rod. By adjusting the distance between the actuator and valve seat, the control valve can be used to set a pressure difference between the control valve inlet and control valve outlet, a volume flow through the control valve or similar. The control actuator of the control valve can be an electric, pneumatic or hydraulic control actuator, for example. Single-acting or double-acting control actuators for control valves are known.

The sensor device comprises a position sensor and a lever arm for converting a linear stroke movement of a control rod of the control valve into a corresponding transmission movement mapped on the position sensor. The lever arm can rotate about a fixed pivot point of the sensor device. In particular, the lever arm is arranged and adapted to convert the stroke movement into a rotational transmission movement.

According to the disclosure, it is provided that the lever arm has a coupling for position-true rotationally movable connection of the lever arm to a reference point of the control rod. The coupling is position-true with respect to the reference point of the control rod.

The lever arm comprises at least one first lever section and at least one second lever section movable relative to the first lever section. The first lever section is preferably arranged close to the pivot point, preferably mounted at the pivot point. The second lever section is preferably provided with the coupling and is connected or connectable to the reference point of the control rod. The first lever section may generally be arranged closer to the pivot point than the second lever section and consequently be referred to as the proximal lever section. The second lever section may generally be arranged further distanced from the pivot point in relation to the first lever section and consequently referred to as the distal lever section. The two-part or multi-part design of the lever arms of the sensor device according to the disclosure makes it possible both to connect the lever arm to the reference point of the control rod in a position-true manner and to mount it so that it can rotate about a fixed pivot point of the sensor device. The movability of the lever sections relative to each other is preferably clearly defined kinematically. In an exemplary embodiment, it is provided that each position of the first lever section can be clearly assigned a corresponding position of the second lever section. Along the travel of the control rod from a first extreme position, for example the closed position, to a second extreme position, for example the maximum open position, the first lever section and the second lever section complete a respective lever section movement, wherein preferably a specific position of the first lever section and/or a specific position of the second lever section can be clearly assigned to each position of the control rod. In particular, a clearly defined movability of the first lever section relative to the second lever section can be provided. The movability of the first lever section relative to the second lever section is preferably low backlash and/or low friction. In an exemplary embodiment, the sensor device is matched to the control valve in such a way that a clearly defined movability of the first lever section and/or the second lever section in relation to the position of the reference point is ensured. Due to the multi-part design of the lever arms with mutually movable first and second lever sections, a precise measurement, in particular in the closing range, can be achieved in combination with a large measuring travel even with a compactly constructed sensor device.

According to a further development of the sensor device according to the disclosure, the first lever section is translationally movable relative to the second lever section in a translational direction defined by the pivot point and the reference point. In an exemplary embodiment, the reference point is stationary on a stroke rod of the control valve. Regardless of the current position of the control rod, the lever sections always move translationally relative to each other, in particular exclusively translationally. It may be provided that the lever arm consists of at least two, exactly two or more, in particular exclusively, translationally movable lever sections relative to each other. A pivotably movable lever arm, which has two or more lever sections that can move translationally relative to one another, can be arranged and adapted to convert a linear stroke movement of the control rod into a preferably translational movement at the position sensor. For the sensor device on the process plant, mapping the linear stroke movement of the control rod as a corresponding rotary transmission movement on the position sensor can be particularly useful, especially in combination with magnetoresistive sensors.

In an expedient further development of a sensor device according to the disclosure, it is provided that the first lever section has a telescopic sleeve relative to the second lever section, in particular as the first lever section, and a telescopic rod guided translationally in the telescopic sleeve, in particular as the second lever section. Alternatively, the first lever section can form a telescopic rod which is guided within the second lever section realized as a telescopic sleeve. In particular, the telescopic sleeve and the telescopic rod have cross-sections corresponding in shape to one another. In an exemplary embodiment, the telescopic sleeve and the telescopic rod are matched to each other according to a sliding fit or a clearance fit. For example, the telescopic sleeve can comprise or consist of at least one plain bearing bush, for example a plain bearing bush comprising or consisting of a plastic, brass, bronze, brass-bronze and/or a layered composite material, such as DU®. A sliding bearing layer composite material can, for example, be composed of a running layer, in particular of a plastic, preferably PTFE, and/or a soft metal, such as lead, optionally a porous layer, e.g. of metal, in particular bronze, a support layer, in particular of metal, preferably comprising or consisting of steel, and/or a corrosion protection layer, for example comprising or consisting of tin. The telescopic sleeve preferably realizes a linear guide for the telescopic rod. Alternatively, or additionally, the telescopic sleeve may comprise or consist of a recirculating ball linear bearing. It may be expedient to form the telescopic sleeve with a shorter longitudinal extension than the telescopic rod, wherein in particular the longitudinal extension of the telescopic sleeve and the telescopic rod are matched to one another such that, irrespective of the stroke position of the reference point, at least a part, in particular at least a large part (i.e. at least 50% of the longitudinal extension), of the telescopic sleeve, preferably the entire longitudinal extension of the telescopic sleeve, is always occupied by the telescopic rod.

According to one embodiment of the sensor device, the first lever section is rigidly connected to a pivot joint for rotation about the pivot point. Alternatively, or additionally, according to one embodiment of the sensor device, the second lever section is rigidly connected to the coupling. The coupling provided at the reference point performs the stroke movement according to the current stroke position of the control rod. At or near the pivot point, the transmission movement mapping the stroke movement can be detected by the position sensor of the sensor device. In an exemplary embodiment, the lever arm is connected both rigidly, in particular non-rotatably, to the coupling and rigidly, in particular non-rotatably, to the pivot joint, wherein the movability of the lever arm sections relative to one another is arranged and adapted to ensure length compensation of the lever arm during a linear actuating movement of the control rod in relation to the pivot point. A rigid, non-rotatable connection of at least one lever section to the coupling, in particular the control rod, and/or the pivot joint promotes the high precision of the measurement.

In another embodiment of a sensor device that can be combined with the previous ones, the lever arm has at least one indicator representing the relative position of the first lever section with respect to the second lever section. The indicator can be realized, for example, by a scale on the first and/or second lever section, in particular the telescopic rod. In combination with lever sections that are translationally movable in relation to one another, the indicator can represent a length specification, for example regarding the total length of the lever or regarding the translationally moved length of one lever section in relation to the other lever section. Such an indicator can allow manual reading, for example for the purpose of initializing and/or calibrating the sensor device.

According to one embodiment of a sensor device, it is provided that the lever arm is surrounded by a sheath, such as a bellows, for example a concertina bellows, in particular made of rubber or an elastomer. The sheath extends at least sectionally along the lever arm in the direction of translation, wherein in particular the sheath surrounds the lever arm completely and/or surrounds it for the most part in the direction of translation, in particular at least 50%, preferably at least 66%, particularly preferably at least 75%. Alternatively, or additionally, the sleeve can be deformed corresponding to the relative position of the first lever section in relation to the second lever section. For example, the sheath can be deformable in the direction of translation and can be firmly connected to the first lever section in the portion of the pivot point and firmly connected to the second lever section in the portion of the reference point.

In one embodiment of the sensor device, the lever arms may comprise three or more lever sections that are movable relative to one another, in particular translationally movable, in particular translationally movable in the direction of translation. In an exemplary embodiment, the lever arm comprises several lever sections movable relative to one another in the direction of translation. The lever arm can, for example, be realized as a multi-link telescopic lever arm, which comprises several telescopic rod and/or sleeve links nested within one another. A multi-link embodiment of the lever arm can be particularly useful for large control valves if, for example, a large linear travel is to be detected with the sensor device, but at the same time only a small distance is available between the control rod and the position sensor transversely to the stroke direction, which is in particular less than half of the travel.

In particular, in one embodiment of the sensor device, the coupling comprises a ball and socket joint or a pivot joint. A pivot joint can be provided for particularly precise transmission of the position and/or movability and a ball and socket joint can be provided to provide tolerance for thermal deformations or different installation constellations, for example. A ball and socket joint or similar can, for example, compensate for any rotational movements of the valve rod around its stroke axis.

In an exemplary embodiment, the sensor device comprises sensor electronics connected to the position sensor, in particular a magnetoresistive sensor. The sensor electronics are preferably arranged and adapted to determine a linearized output value based on the, in particular rotational, transmission movement detected by the position sensor. In particular, the sensor electronics are arranged and adapted to perform an angle determination in relation to a rotational transmission movement, for example with the aid of a geometric function, such as an arc tangent function, arc sine function or arc cosine function, and then to perform a systematic linearity adjustment. Alternatively, the sensor electronics can be arranged and adapted to perform an angle determination in relation to a rotational transmission movement using a linearity-adjusted angle table, such as an arc tangent table. Linearity adjustment can generally refer to the conversion of a position sensor signal, such as an xMR sine or cosine signal, into a linear angle signal. In the case of a control valve cooperating with the sensor device, position controller electronics may be provided which are arranged and adapted to actuate the control actuator as a function of an actual position value detected by the sensor device. In particular, the positioner electronics can be equipped with a signal input, such as an analog-to-digital converter, to receive actual position values from the sensor electronics. In particular, the positioner electronics can be arranged and adapted to detect an analog current signal at a signal input, which represents an actual position value. Particularly In an exemplary embodiment, positioner electronics can be provided which are arranged and adapted to receive a linear, in particular analog signal, preferably a current signal, representing an actual position value, and to take this into account for actuating the control actuator. This is intended to ensure compatibility with various position sensors on the positioner side. The sensor electronics can be arranged and adapted to provide a signal, preferably an analog signal, in particular an analog current signal, which represents an actual position value. By arranging and adapting the sensor electronics to output a linearized output value that represents an actual position value, compatibility of the sensor electronics with a wide variety of positioners can be supported. In particular, it may be provided that the sensor electronics are integrated into the electronics, especially the positioner electronics, of the control valve. Conventional sensor devices do not have systematic linearity adjustment. Surprisingly, it has proven to be advantageous in terms of measurement accuracy to provide such sensor electronics in combination with the lever arm consisting of movable lever sections.

Additionally, or alternatively, the sensor electronics may be arranged and adapted to determine an angular output signal as a function of a transmission movement detected by the position sensor, which is realized as a rotary angle sensor, for example as a magnetoresistive position sensor, such as an xMR sensor, in the form of a rotary movement. The angle output signal can, for example, be output by the sensor electronics to actuator device electronics or used by the sensor electronics as an intermediate result to determine an output signal, in particular an analogue and/or linearized output signal. In an exemplary embodiment, the sensor electronics according to this embodiment are arranged and adapted to calculate the angular output signal taking into account a radial offset and/or angular offset between a position transmitter axis of rotation of a position sensor, such as a magnet, which is in particular rotationally fixed on the lever arm, and a position receiver axis of rotation, such as the axis of rotation of a position sensor, preferably magnetoresistive, which is attached in particular in a stationary manner in relation to a sensor housing, a support structure and/or a valve housing. Systematic measurement errors can occur as a result of mounting tolerances when attaching the position sensor, for example an xMR sensor, and/or due to the alignment of a position sensor, such as a rotary magnet that represents the transmission movement, in relation to an axis of rotation of the lever arm or the position sensor. According to this practical design, the sensor electronics can be pre-calibrated ex works, for example, in order to take account of assembly tolerances by means of calibration using the sensor electronics. In this way, a particularly precise angle sensor can be realized.

According to a further development of a sensor device with sensor electronics, the latter is arranged and adapted to detect the stroke amplitude, the distance and/or at least one lever length, in particular corresponding to the first reversal point, the second reversal point and/or the neutral position, in order to determine the linearized output value. The lever length can be determined using an indicator, for example. In an exemplary embodiment, the first reversal point corresponds to a closed position of the control valve and the second reversal point corresponds to a maximum open position of the control valve. Alternatively, or additionally, the first reversal point and/or the second reversal point can correspond to a maximum first or second deflection of the control actuator. The stroke amplitude can preferably be defined by the distance between the first reversal point and the second reversal point.

The disclosure also relates to a measuring arrangement for a control valve of a process plant, such as a chemical plant, a power plant, a food processing plant, or the like. The measuring arrangement comprises a linearly movable control rod for transmitting a stroke movement from a control actuator of the control valve to an actuator of the control valve. A reference point is defined on the control rod. The reference point is displaceable with the control rod by a stroke amplitude between a first reversal point, which corresponds to a closed position of the actuator, and a second reversal point, which corresponds to a maximum open position of the actuator. The measuring arrangement also comprises a support structure, such as a yoke, for attaching the control actuator to a valve housing of the control valve that receives the actuator. Furthermore, the measuring arrangement comprises a sensor device arranged in a fixed position on the support structure. In particular, the sensor device can be embodied as described above. The sensor device of the measuring arrangement comprises a position sensor, in particular a magnetoresistive sensor. The sensor device comprises a lever arm which is rotationally movable about a fixed pivot point of the sensor device. In an exemplary embodiment, the pivot point is stationary in relation to the support structure. The lever arm of the sensor device is arranged to convert the linear stroke movement into a corresponding transmission movement mapped on the position sensor. The mapped transmission movement is in particular rotational, wherein preferably the transmission movement is mapped for the position sensor in the portion of the pivot point, particularly preferably at the pivot point. According to the disclosure, it is provided that the pivot point is arranged offset in relation to a center point of a stroke amplitude in the direction of the first reversal point. In conventional sensor devices with position sensors, a mirror-symmetrical arrangement of the pivot point of a lever arm in relation to a stroke amplitude of the control rod is generally provided for historical reasons, wherein the lever arm experiences the same deflection (in the opposite direction) in the first reversal point and in the second reversal point and wherein the measurement accuracy is often highest in a middle position between the reversal points. By displacing the pivot point in the direction of the first reversal point, which corresponds to the closed position, according to the disclosure, the portion of the highest measuring accuracy of the measuring arrangement is shifted towards the closed position. A high measuring accuracy in relation to the stroke position of the actuator in the portion of the closed position is advantageous because in this portion, slight changes in position have a particularly high impact on the pressure difference and/or the process fluid flow rate at the actuator device. Furthermore, due to the particularly high resolution in the closing range, a higher resolution and therefore higher quality diagnosis can be performed with regard to any valve seat wear.

In an exemplary embodiment of a measuring arrangement, the pivot point is offset by at least 5%, in particular at least 10%, and/or no more than 30%, in particular no more than 20%, of the stroke amplitude relative to the center point. In an exemplary embodiment, the pivot point is offset by around 15% of the stroke amplitude relative to the center point. It has been found that such an arrangement of the pivot point of the sensor device allows a high measuring accuracy over a large part of the stroke amplitude or even the entire stroke amplitude, even with a large travel.

According to one embodiment of a measuring arrangement, the pivot point is arranged at a distance from the control rod, in particular from the reference point, orthogonal to the stroke direction by no more than 75%, in particular no more than 66%, preferably by about 50%, of the stroke amplitude. In this way, the mounting space of the measuring arrangement can be minimized.

In one embodiment of the measuring arrangement, which can be combined with the previous ones, the lever arm has a neutral position in which it is oriented perpendicular to the stroke direction. Furthermore, the lever arm has a first deflection corresponding to the first reversal point and a second deflection corresponding to the second reversal point. The deflection preferably refers to the angular offset in relation to the vertical neutral position. The second deflection is greater than the first deflection. In an exemplary embodiment, the maximum possible deflection of the lever arm from its neutral position in the direction of the closed position is smaller than the maximum possible deflection of the lever arm from its neutral position in the direction of the maximum possible open position. It has been shown that a smaller angular displacement in relation to a neutral position is preferable in terms of measurement accuracy, wherein an accurate, particularly high measurement presentation is often required in relation to the closed position and opening position close to the closed position.

In an exemplary embodiment of the measuring arrangement, the lever arm has a pivot amplitude of at least 75°, in particular at least 85°, corresponding to the stroke amplitude. In a further development of the measuring arrangement, which uses a lever arm composed of several lever sections as described above, it can preferably be provided that the pivot amplitude of the lever arm denotes the pivot amplitude of the first and/or proximal lever section of the lever arm. The pivot amplitude is preferably not more than 180°, in particular if a magnetoresistive sensor, such as an AMR sensor, is used as the position sensor in the measuring arrangement.

Alternatively, the disclosure relates to a control valve with a sensor device or measuring arrangement attached thereto. The control valve can, for example, be a globe control valve which has an in particular a linear-moving actor, for actuating a linear-moving actuator of the control valve. The actuator comprises a control valve housing in which the actuator is received. A valve seat that can be at least partially, in particular completely, closed by the actuator is arranged in the control valve housing. The linear movable actuator of the control valve can, for example, be a valve plug or the like, which is translationally movable in a stroke direction relative to the valve seat corresponding to the actuator. The actuator is attached to a control rod. The reference point is defined on the control rod. The control valve optionally comprises a control actuator for actuating the control valve, which can be an electric, pneumatic or hydraulic control actuator, for example. In an exemplary embodiment, the control valve comprises a support structure attached to the valve housing, such as a yoke, to which the control actuator is attached or can be attached. The sensor device is attached to the control valve, preferably to the support structure. The lever arm of the sensor device is connected to the reference point of the control rod in a position-true manner. In an exemplary embodiment, the sensor electronics are calibrated, in particular pre-calibrated in the factory. The sensor device comprises sensor electronics. The sensor electronics are arranged and adapted to determine a preferably linearized output value based on the, in particular rotational, transmission movement detected by the position sensor.

The disclosure also relates to a method for mounting a sensor device as described above. During mounting of the sensor device, control valve-related data is recorded. In an exemplary embodiment, control valve-related data generally relate to data of the valve mechanism on which the sensor device is to be mounted. Control valve-related data can, for example, relate to the position of the control rod at a first reversal point, which corresponds to a closed position of the actuator, and/or to the position of the control rod at a second reversal point, which corresponds to a maximum open position of the actuator. Alternatively, or additionally, control valve-related data can refer to a stroke amplitude between the first reversal point and the second reversal point or to a position of a reference point on the control rod. Further alternatively or additionally, control valve-related data may relate to geometric data of a support structure, such as a yoke, for attaching the control actuator to a valve housing of the control valve receiving the actuator.

In the method for mounting the sensor device, it is further provided that data related to the sensor device is recorded. In an exemplary embodiment, data relating to the sensor device of a sensor device which can be mounted on different control valves are considered, if necessary considering the specific control valve on which the sensor device is mounted according to the method according to the disclosure or its control valve-related data. Data relating to the sensor device may, for example, relate to the distance between the sensor device, in particular the pivot point of the sensor device, and the control rod. In particular, data related to the sensor device may concern a distance between a pivot point of the sensor device and a reference point defined on the control rod. Alternatively, or additionally, the data relating to the sensor device may relate to at least one lever length, in particular corresponding to a first reversal point, to the second reversal point and/or to the neutral position. Further alternatively or additionally, the data relating to the sensor device may relate to at least one deflection of the lever arm, in particular corresponding to the first and/or second reversal point.

Furthermore, in the method according to the disclosure for mounting a sensor device, it is provided that a mounting specification is determined based on the control valve-related data and on the data related to the sensor device. Furthermore, it is provided that the mounting specification for attaching the sensor device to the control valve, in particular the support structure, is output on a display unit. According to an exemplary embodiment, the display unit can be part of the sensor device and/or the control valve, for example a display of a positioner. Alternatively, or additionally, according to an exemplary embodiment, the display unit can be realized as a display of a display unit separate from the sensor device and/or the control valve, such as a laptop display or a smartphone display.

In one embodiment of the method according to the disclosure for mounting the sensor device, it is provided that the sensor device is attached to the control valve, in particular the support structure, in a pre-mounting state before at least some of the control valve-related data and/or at least some of the data related to the sensor device are recorded, which are considered for determining the mounting specification. In one or more embodiments, as part of the method according to the disclosure for mounting a sensor device on a control valve, at least some of the data relating to the sensor device may be recorded in the pre-assembly state.

In a further embodiment of the method for mounting the sensor device, at least some of the data relating to the sensor device is recorded by means of the sensor device, in particular the position sensor.

Alternatively, or additionally, in one embodiment of the method, the mounting specification can be optimized based on the control valve-related data and the data related to the sensor device. Optimization can take place in particular with regard to minimizing the lever length and/or with regard to a measurement resolution of the stroke, preferably in the closed position. In this way, for example, the mounting space of the measuring arrangement can be minimized and/or the measuring accuracy can be maximized with respect to a predetermined portion, in particular in the closing position.

A sensor device according to the disclosure is generally referred to below by the reference sign 1. The sensor device 1 comprises as components a position sensor 3 and a lever arm 4.

A measuring arrangement according to the disclosure is hereinafter generally designated by the reference sign 10. The measuring arrangement 10 comprises as components a linearly movable control rod 5, a support structure 13 and a sensor device 1 with a rotationally movable lever arm 4 with a pivot point 3. The control actuator and the control valve, in particular its valve housing and actuator, of the measuring arrangement 1 are not shown in detail.

FIGS. 1 to 3 show a sensor device 1, which is fixedly attached to a support structure 13, such as a yoke, and a control rod 5 guided in the support structure 13. A reference point 54 is defined on the control rod 5, which is fixed in relation to the control rod 5. The reference point 54 moves with the control rod 5. The reference point 54 performs the same linear movement as the control rod 5.

The sensor device 1 has a lever arm 4 which is rotatably mounted at a pivot point 31 in relation to the support structure 13 or a housing of the sensor device 1 and is stationary.

The lever arm 4 is hinged to the control rod 5 at the reference point 54. In an exemplary embodiment, the lever arm 4 is rotatably mounted at the reference point 54 and stationary with respect to the control rod 5. Transversely, in particular orthogonally, to the control rod 5, the pivot point 31 of the lever arm 4 is arranged at a distance a from the control rod 5.

The shortest longitudinal distance 1 between the pivot point 31 and the reference point 54 depends on the current position of the control rod 5. In a neutral position, not shown in detail, in which the longitudinal distance is oriented orthogonally to the linear direction of movement H of the control rod 5 and extends through the pivot point 31, the longitudinal distance 1 is minimal. The direction of movement of the control rod can be referred to as the stroke direction H. Starting from the neutral position, the longitudinal distance 1 increases during a movement reference point 54 in the direction of a first reversal point of the first reversal point (FIG. 3) as well as in the direction of the second reversal point (FIG. 1). The longitudinal distance 1 is greater at the second reversal point than at the first reversal point.

The first lever section 41 and the second lever section 43, which together form the lever arm 4, are translationally movable relative to one another. In the exemplary embodiments shown in the figures, the first lever section 41 may be realized as a telescopic sleeve and the second lever section 43 may be realized as a telescopic rod guided therein. A sliding fit is preferably provided between the telescopic rod and telescopic sleeve, in particular with little friction and/or little play.

A coupling 45 is provided at the reference point 54, which connects the lever arm 4, in particular its second lever section 43, to the control rod 5.

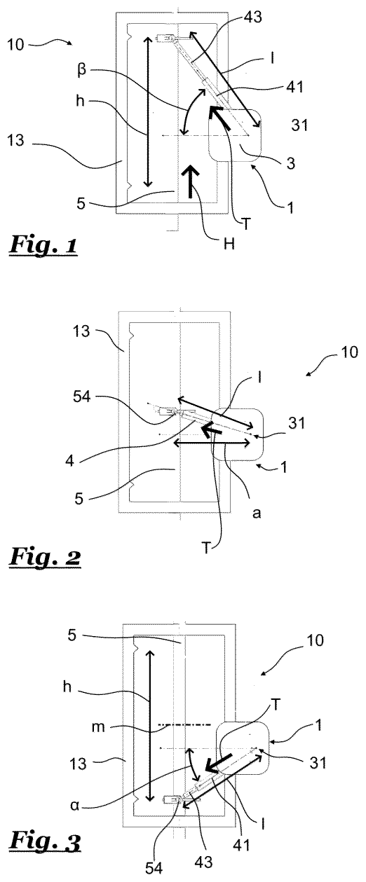

In the measuring arrangement 10 according to the disclosure, the neutral position as shown in FIG. 2 is displaced by approximately 15% of the stroke amplitude h in relation to a center point m of the stroke amplitude h in the direction of the first reversal point corresponding to the closed position. In relation to the neutral position, the first deflection α of the lever arm 4 or of the first lever section 41 rotatably mounted at the pivot point 31 is smaller at the first reversal point than its second deflection β at the second reversal point.

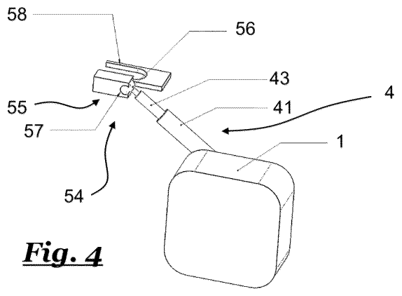

FIG. 4 shows a perspective view of an exemplary embodiment of the sensor device 1 according to the disclosure. The coupling 45 (at reference point 54) for connecting the lever arm 4 to the control rod (not shown in detail) comprises a ball and socket joint 55. The ball and socket joint 55 comprises a ball head 56 rigidly connected to the lever arm 4 and a guide groove 57 or socket complementary in shape to the ball head 56. The guide groove 57 is rigidly connected to a mounting bracket 58, which is attached or attachable to the control rod.

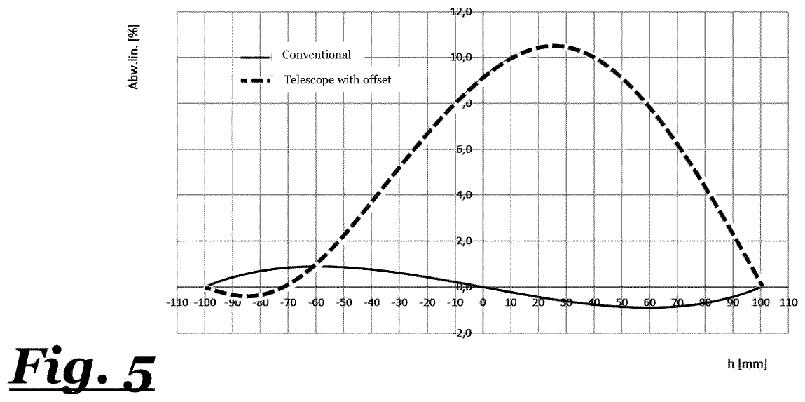

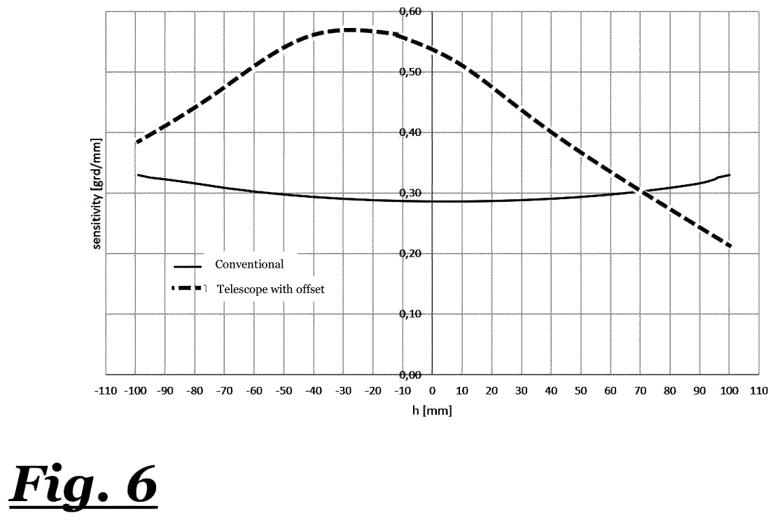

The diagrams shown in FIGS. 5 and 6 relate to measuring arrangements for the same stroke of 200 mm, for example. In the conventional sensor device, equally large maximum deflections of ±30° are provided for a distance of 190 mm between the pivot point of a lever arranged at the height of the stroke path center point m and the control rod. With regard to the sensor device 1 according to the disclosure, it may be assumed that, as shown in the figures, a telescoping lever arm 4 consisting of two lever sections 41, 43 is provided. The stroke path h is again 200 mm, wherein the transverse distance a between pivot point 31 and control rod 5 is reduced to 100 mm. The pivot point 31 is offset by 30 mm from the center point m of the stroke path h in the direction of the closed position (FIG. 3). At the first reversal point, the lever arm 4 has a first deflection α of approximately 52.4°. At the second reversal point, the lever arm 4 has a second deflection β of approximately 35.0°.

Depending on the stroke position sᵢ, the current deflection ωᵢ can be calculated using the formula (1)

$${ω}_{i} = arctan ( ( {s}_{i} - Δ m ) / h )$$

wherein h denotes the stroke of the control rod, μm the distance of the pivot point 31 in relation to the center m of the stroke h parallel to the direction of movement H of the control rod 5, and sᵢ the stroke position in relation to a neutral position on the plane of the center m.

A linearized curve can be determined on the base of a straight line through the end points of a curve that plots the deflection ω against the stroke position s at the reversal points. The difference between the linearized curve and the formula (1) can be referred to as the linearity error. As can be seen in FIG. 6, the absolute linearity error of the sensor device 1 according to the disclosure under the above-mentioned assumptions in the portion of a current stroke position sᵢ between the first reversal point corresponding to the closed position and an intersection point at a stroke position of, for example, about −60 mm is smaller than or equal to the linearity error of a comparable conventional sensor device. In the remaining portion of the stroke path h, the linearity error is greater. Surprisingly, the inventors have discovered that the linearity error is systematic and can be mathematically neutralized by sensor electronics to determine an output value, for example using a corresponding stored table or calculation routine. Contrary to widespread prejudice, the large linearity error of the sensor device according to the disclosure can be accepted without having to accept a qualitative loss of measurement precision. In the portion of the closed position, a sensor device according to the disclosure can therefore be operated without linearization of an output value of the sensor device, if necessary.

The sensitivity E [deg/mm] of the sensor device can be determined using the formula (2)

$$E = ( {s}_{1} * {ω}_{1} ) / ( {s}_{2} * {ω}_{2} )$$

wherein sᵢ denotes the current stroke position and wherein ox denotes the current deflection for two adjacent stroke positions i.

With a sensor device 1 according to the disclosure, a significantly increased sensitivity compared to conventional sensor devices can be achieved in the portion of the first reversal point of the, preferably the closed position, possibly up to a neutral position or even beyond. It has been found that a reduced sensitivity in the portion of a second reversal point, preferably the maximum opening position, compared to conventional sensor devices is readily acceptable, since slight changes in the valve position in the portion of the second reversal point have practically no relevant effects for a positioner.

The features disclosed in the above description, the figures and the claims may be of importance both individually and in any combination for the realization of the disclosure in the various embodiments.

### REFERENCE SIGNS

1 Sensor device
3 Position sensor
4 Lever arm
5 Control rod
10 Measuring arrangement
13 Support structure
31 Pivot point
41 First lever section
43 Second lever section
45 Coupling
54 Reference point
55 Ball and socket joint
56 Ball head
57 Guide groove
58 Mounting bracket
a Distance
h Stroke amplitude
l Lever length
m Center point
H Stroke direction
T Translation direction
α First deflection
β second deflection
γ pivot amplitude

1. A sensor device for a control valve of a process plant, the sensor device comprising:
a position sensor; and
a lever arm rotatable about a fixed pivot point of the sensor device and configured to convert a linear stroke movement of a control rod of the control valve into a corresponding transmission movement mapped on the position sensor, wherein the lever arm comprises:
a coupling configured to connect the lever arm to a reference point of the control rod in a position-true, rotationally movable manner; and
at least one first lever section and at least one second lever section movable relative to the first lever section.

2. The sensor device according to claim 1, wherein the first lever section is translationally movable relative to the second lever section in a direction of translation defined defined-by the pivot point and the reference point.

3. The sensor device according to claim 1, wherein the lever arm comprises a telescopic sleeve and a telescopic rod guided translationally in the telescopic sleeve.

4. The sensor device according to claim 1, wherein:
the first lever section is rigidly connected to a pivot joint and adapted to rotate about the pivot point; and/or
the second lever section is rigidly connected to the coupling.

5. The sensor device according to claim 1, wherein the lever arm comprises at least one indicator representing a relative position of the first lever section with respect to the second lever section.

6. The sensor device according to claim 1, wherein the lever arm is surrounded by a casing extending, at least sectionally, in a direction of translation along the lever arm and/or being deformable corresponding to the relative position of the first lever section with respect to the second lever section.

7. The sensor device according to claim 1, wherein the lever arm comprises at least three lever sections movable relative to one another.

8. The sensor device according to claim 1, wherein the coupling comprises a ball and socket joint or a pivot joint.

9. The sensor device according to claim 1, further comprising sensor electronics connected to the position sensor and adapted to;
(a) determine a linearized output value based on the transmission movement detected by the position sensor; and/or
(b) determine an angular output signal as a function of the transmission movement, detected by the position sensor realized as a rotary angle sensor, in the form of a rotary movement,
wherein the sensor electronics are adapted to consider an angular offset and/or radial offset between a position transmitter axis of rotation and a position receiver axis of rotation of the position sensor.

10. The sensor device according to claim 9, wherein the sensor electronics are further adapted to detect a stroke amplitude, a distance, and/or at least one lever length, to determine the linearized output value.

11. A measuring arrangement for a control valve of a process plant, the measuring arrangement comprising:
a linearly movable control rod adapted to transmit a stroke movement from a control actuator of the control valve to an actuator of the control valve, wherein a reference point is defined on the control rod, the reference point being displaceable with the control rod by a stroke amplitude between a first reversal point, which corresponds to a closed position of the actuator, and a second reversal point, which corresponds to a maximum open position of the actuator,
a support structure adapted to fasten the control actuator to a valve housing of the control valve which receives the actuator,
a sensor device arranged in a stationary manner on the support structure and including a position sensor and a lever arm rotatable about a fixed pivot point of the sensor device and adapted to convert the linear stroke movement into a corresponding transmission movement mapped on the position sensor, wherein the pivot point is arranged offset in relation to a center point of a stroke amplitude in a direction of the first reversal point.

12. The measuring arrangement according to claim 11, wherein the pivot point is arranged offset by at least 5% and/or not more than 30% of the stroke amplitude relative to the center point.

13. The measuring arrangement according to claim 11, wherein the pivot point is arranged at a distance from the control rod orthogonal to the stroke direction by no more than 75% of the stroke amplitude.

14. The measuring arrangement according to claim 11, wherein the lever arm comprises a first deflection corresponding to the first reversal point and a second deflection corresponding to the second reversal point in relation to a neutral position in which the lever arm is oriented perpendicular to the stroke direction, wherein the second deflection is greater than the first deflection.

15. The measuring arrangement according to claim 11, wherein the lever arm comprises a pivot amplitude of at least 75° corresponding to the stroke amplitude.

16. A method for mounting a sensor device, the method comprising:
detecting control valve-related data including a stroke amplitude of a control rod of a control valve between a first reversal point, which corresponds to a closed position of an actuator of the control valve, and a second reversal point, which corresponds to a maximum open position of the actuator, a position of a reference point on the control rod, geometric data of a support structure to fasten the actuator to a valve housing of the control valve receiving the actuator;
detecting data relating to the sensor device including a distance between the sensor device and the control rod, at least one lever length, at least one deflection of a lever arm;
determining a mounting specification based on the control valve-related data and the data related to the sensor device; and
outputting, to a display, the mounting specification for attaching the sensor device to the control valve.

17. The method for mounting a sensor device according to claim 16, wherein the sensor device is attached to the control valve in a pre-mounting state before at least some of the control valve-related data and/or at least some of the data related to the sensor device are detected.

18. The method according to claim 17, wherein at least some of the data related to the sensor device is detected by the sensor device.

19. The method according to claim 16, further comprising optimizing the mounting specification based on the control valve-related data and the data related to the sensor device, to minimize the lever length and/or with respect to a measurement resolution of the stroke.

20. The sensor device according to claim 9, wherein the sensor electronics are further adapted to perform an angular determination in relation to a rotational transmission movement and subsequently perform a systematic linearity adjustment or an angular determination using a linearity-adjusted angular table.
